(19) United States
(12) Patent Application Publication
(10) Pub. No.: US 2007/0112773 A1
(43) Pub. Date: May 17, 2007

(54) Method for assuring flash programming integrity

(76) Inventor: John Joyce, West Bloomfield, MI (US)

Correspondence Address: TUNG & ASSOCIATES, 838 WEST LONG LAKE, SUITE 120, BLOOMFIELD HILLS, MI, 48302, US

(21) Appl. No.: 11/274,108

(22) Filed: Nov. 14, 2005

(51) Int. Cl. G06F 17/30

(52) U.S. Cl. 707/9

(57) ABSTRACT

A method is provided for assuring that only the correct version of a software update is permitted to be installed in a computer controlled module, such as a vehicle controller. Each version of the software is embedded with a unique identifier, and each software update has an embedded list of the identifiers of the software versions which it is authorized to update or replace. A flashloader is used to determine if the identifier of the software in the controller is present in the list embedded in a proposed update, and installs the update if a match is found. Checksums and encryption of the identifiers can be used to enhance reprogramming integrity.

### FIELD OF THE INVENTION

This invention generally relates to the installation of software revisions in a computer-based controller, and deals more particularly with a method for assuring that only the correct version of a software revision is used to update the controller.

### BACKGROUND OF THE INVENTION

Current vehicles employ multiple, onboard electronic control units to monitor and control various functions on the vehicle. These computer-based control units, sometimes referred to as controllers, are inter-connected by one or more bus networks and are controlled by application software stored in reprogrammable, onboard memories, sometimes referred to as flash memories. Examples of onboard controllers include body controllers, passive restraint controllers, wireless communication controllers, engine controllers and drive train controllers.

In order to reduce warranty costs and improve customer satisfaction, it is often desirable or necessary to change the software in vehicle controllers as a service procedure. In some cases, the software change may consist of changing only certain components or modules of a software application, while in other cases, the procedure may involve replacing the entire software application with an updated version. In any event, it is important that the correct software update be installed in the correct module for a particular vehicle and vehicle configuration. Because of the variety of vehicles, models and configurations, a wide number of software versions are necessary, thus requiring service personal to verify that they are installing the correct version of a software update for a particular vehicle. While procedures can be specified for carrying out the software updates by service personal, there is no assurance that they will follow the procedures, or that they will carry out the procedure correctly. Further complicating the problem of installation of the correct updates, a variety of aftermarket tools are now available to both authorized and unauthorized service personal, possessing sufficient control authority that will allow the service personal to circumvent procedures established by the original equipment manufacturers for installing software updates.

Currently, service personal are provided with information that allows them to associate software updates with various hardware configurations. Specifically, a central database is maintained containing all of the software releases for all controller modules and associated vehicle configurations. Each software version is assigned a part number which identifies the hardware and/or module with which it is to be used. This information is periodically updated and provided to service personal. Service personnel carry out the reprogramming procedure using a reprogramming tool which contains the software update. The service person connects this tool to the controller through a gateway or data bus on the vehicle. An onboard flashloader uploads the software update from the tool and uses it to reprogram the application software stored in the onboard flash memory.

From the forgoing, it is apparent that the current procedure used to specify and install software updates relies on numerous steps and personal from differing business organizations to collect, disseminate and use the software update information properly in order to assure complete integrity of controller reprogramming. The procedure is subject to human error, mistakes in data transmission, as well as the improper use of the information by unauthorized service personal.

Accordingly, there is a need in the art for a method of reprogramming or updating software in controllers which overcomes the problems discussed above, and assures that controllers are reprogrammed only with the correct software updates.

### SUMMARY OF THE INVENTION

According to one aspect of the invention, a method is provided for updating software applications in computerized controllers. The method comprises the steps of: embedding an identifier in each of the software applications that uniquely identifies the application; embedding in a software update, a list of identifiers for the software applications that the update is authorized to update; determining whether the identifier of a software application present in a controller is present in the list embedded in a proposed software update; and, installing the proposed software update in the controller only if the identifier of the software application to be updated is determined to be present in the list embedded in the proposed software update. A flashloader resident in the controller is preferably used to compare the identifier of the software application in the controller with the list embedded in the proposed update. Further reprogramming integrity may be obtained by maintaining a count of the number of times a comparison is made between the identifier and the list, and terminating attempts to install the software update if the count exceeds a pre-selected value. A checksum procedure may be carried out to verify the integrity of the software application present in the controller before the update is installed. The identifier may be encrypted to increase reprogramming integrity.

According to another aspect of the invention, a method is provided for updating software in a controller comprising the steps of: storing an identifier in the controller that uniquely identifies the software present in the controller; storing with update software a list of the unique identifiers for software that the update software is authorized to update; determining whether the stored identifier is present in the list of identifiers; and, updating the software in the controller with the update only if the identifier is determined to be present in the list. The update that is installed may optionally comprise only a portion of the software application present in the controller. In order to increase reprogramming integrity, a second copy of the identifier associated with the software in the controller may be stored and compared with a first copy thereof in order to verify that the correct identifier is being compared with the list.

According to still another aspect of the invention, a method is provided for updating a software application in a computerized controller. The method comprises the steps of: determining values for identifiers in a configuration stored in the controller; determining criteria that the identifier values in the configuration must satisfy in order for a software update to be authorized; determining whether the criteria are satisfied; if criteria are satisfied, performing a software update; and, if criteria are not satisfied, inhibiting the software update. The criteria may be stored in the computerized controller, or in a new software application. Determination of whether the criteria have been satisfied can be performed using a flashloader that updates the software application. The values for identifiers in the configuration may be embedded in the software application, and in a new software application using the flashloader.

These non-limiting features, as well as other advantages of the present invention may be better understood by considering the following details of a description of a preferred embodiment of the present invention. In the course of this description, reference will frequently be made to the attached drawings.

### BRIEF DESCRIPTION OF THE DRAWINGS

FIG. 1 is a broad block diagram of a controller connected with a reprogramming tool.

FIG. 2 is a block diagram showing the overall steps of a method for assuring flash programming integrity in accordance with the present invention.

FIG. 3 is a table showing how identifiers are used to associate vehicle configuration with application software.

FIGS. 4 & 5 are tables showing criteria and actions for two versions of the application software used with the configuration shown in FIG. 3, useful in illustrating one embodiment of the invention.

FIGS. 6 & 7 are tables showing criteria and actions for two versions of the application software used with the configuration shown in FIG. 3, useful in illustrating an alternate embodiment of the invention.

### DETAILED DESCRIPTION OF THE PREFERRED EMBODIMENT

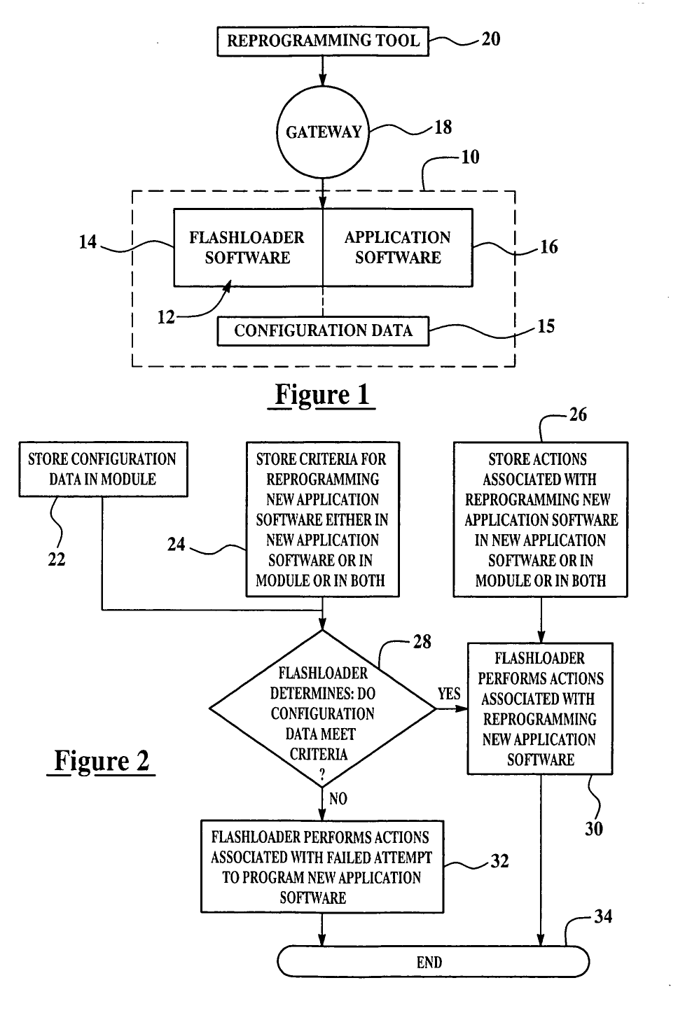

Referring first to FIG. 1, a computer based controller 10 includes an ECU and associated memory (not shown) as well as an embedded flashloader 12 which is used to reprogram the ECU with useful updates or corrections. The flashloader 12 may be implemented in either firmware or software, but typically comprises a module having a physical memory divided into two sections respectively storing flashloader software 14 and application software 16. The section of the memory containing the flashloader software 14 is protected, while the memory portion storing the application software 16 is reprogrammable, sometimes referred to in the art as a flash memory. The controller 10 further includes memory in which configuration data 15 is stored. The configuration data 15 characterizes the device which is controlled by the controller 10. In the case of a vehicle, for example, the configuration data might comprise the vehicle's identification number, type of drive train, type of braking system, etc. The flash loader software 14 receives the software update from a reprogramming tool 20 and reprograms the application software 16 stored in the controller 10. The flash loader 14 is normally executed by a microprocessor unit (not shown) forming part of the ECU (not shown) within the controller 10.

As will be discussed below, in accordance with the present invention, a method is provided for assuring that the application software 16 is updated or replaced only by a correct version. In other words, a procedure is provided whereby the software update uploaded using tool 20 is verified to be a correct version based on the particular configuration data 15. Referring now also to FIG. 2, the configuration data 15 is stored in the flashloader module 12, as indicated at step 22. Simultaneously, shown at step 24, criteria is stored for reprogramming the new application software. This information is stored either in the new application software, or in the module 12, or in both. As shown in step 26, actions associated with reprogramming the new application software are stored either in the new application software or in the module 12, or in both. The forgoing information having been stored, the flashloader 12 then determines, at step 28, whether the configuration data meets the reprogramming criteria stored at step 24. If the criteria are not met, the flashloader 12 performs actions associated with a failed attempt to program the new application software, as shown at step 32. This action may consist, for example, of simply inhibiting uploading of the new software application.

On the other hand, if the flashloader 12 confirms that the configuration data meets the stored criteria, then, as shown at step 30, the flashloader 12 performs actions associated with reprogramming the new application software, following which, the process ends at 34.

The above described method may be carried out in a variety of ways with different variations. For example, in connection with reprogramming onboard vehicle controllers, a unique identifier may be assigned to each version of a software application that is embedded in the application, or in the module 12 or in both. A list of the identifiers is then embedded in the replacement or update software. This embedded list of identifiers identifies those software applications which the software update is authorized to replace or update. During the course of the reprogramming procedure, the flashloader 12 determines whether the unique identifier of the current application software 16 is found in the list of identifiers embedded in a software update. If the unique identifier is found, then reprogramming is allowed to proceed, otherwise the flashloader 12 prevents the service person from uploading the new software.

A number of procedures can be carried out to further ensure the integrity of the reprogramming process. For example, the flashloader can maintain a count of the number of attempts to reprogram the controller 10, and once a preselected count is reached, the flashloader may terminate the reprogramming. The unique identifier can also include a checksum to confirm that the application corresponding to the identifier has not been altered. The unique identifier and the replacement list of identifiers can be encrypted using a variety of known encryption technologies in order to make it more difficult for an unauthorized person to change the application software. The identifier and the replacement list of identifiers can be located at various locations in the application software file, or the memory in which the file is stored. These locations can be encrypted if desired, to increase security. Further, a duplicate copy of the application software file can be maintained which is compared to the identifier used by the flashloader. If these two do not match, the reprogramming procedure can be terminated.

It should be noted here that although the method described above is normally employed to replace application software files with updated versions, the same method can be used to update individual components within an application, such as calibration, strategy, configuration and various, specific subroutines.

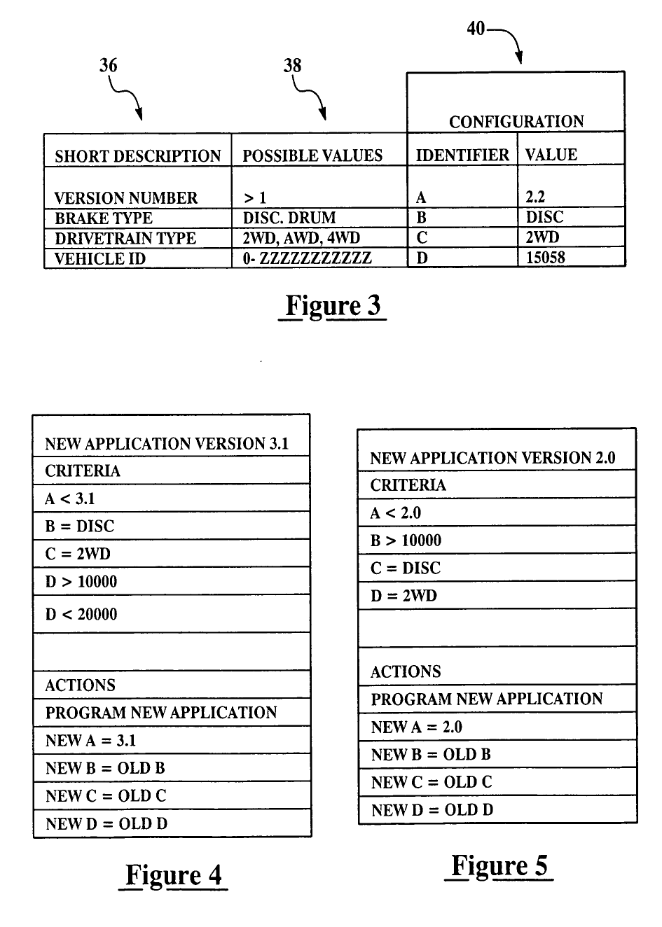

Attention is now directed to FIGS. 3-5 which show one practical implementation of the method of the present invention wherein the current criteria for changing the application software and the actions to be executed if the criteria are met are contained in the new application. A short description of the identifiers is shown in column 36, in this case, comprising the version number, type of brake, type of drivetrain and the vehicle ID. Column 38 simply shows the range of possible values for the identifiers in column 36. Columns 40 in FIG. 3 show the actual configuration of the vehicle in which the software is to be updated. The configuration is defined by the identifiers A-D and their respective values. The configuration data shown in columns 40 is resident in a configuration data memory within the controller 10.

FIG. 4 shows the criteria in one version (3.1) of a new software application that might be used to update a current application, as well as the actions that are to be taken if the criteria are met, based on the configuration shown in FIG. 3. Similarly, FIG. 5 shows the criteria and actions to be taken associated with a different version (2.0) of the software application. If the service person attempts to change the application to version 3.1 shown in FIG. 4, the following events occur. The flashloader reads the criteria in version 3.1 and determines if the configuration matches the criteria. The values of the identifiers in the configuration are compared to the criteria in the new application (2.2<3.1, Disc=Disc, 2WD=2WD, 15058>10000, 15058<20000 are all true). Since the criteria are fulfilled, the flashloader then performs the actions that are also defined in the new application. The result is the application version 3.1 replaces application version 2.2 and the configuration is changed to reflect that the new version number is 3.1.

On the other hand, if the operator attempts to change the application to the new application version 2.0, the following events occur. The values of the identifiers and the configuration are compared to the criteria in the new application. Because the criteria for identifier A is not met (2.2>2.0) the flashloader does not perform the actions defined in the new application. Consequently the application version 2.2 remains in the module.

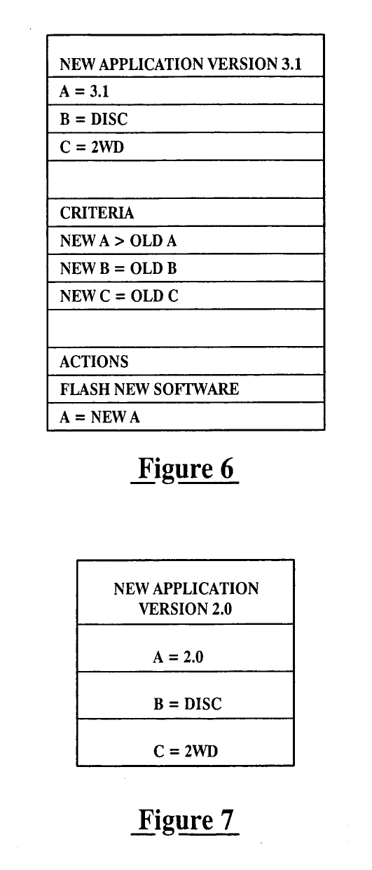

Referring now to FIGS. 5 and 6 as well as FIG. 3, another implementation of the method is shown in which the flashloader contains their criteria for changing the application and the actions to be executed if the criteria are met. If the service person attempts to change the application to the new application version 3.1 shown in FIG. 6, the following events occur. It can be seen that the values satisfy the criteria contained in the flashloader (3.1>2.0, Disc=Disc, 2WD=2WD, are all true). The flashloader then performs the actions that are defined in the flashloader, with the result that application version 3.1 replaces applications version 2.2 and the configuration is changed to reflect that the new version is 3.1.

On the other hand if the service person attempts to change the application to new application version 2.0 shown in FIG. 7, the following occurs. The flashloader reads the values of the identifiers from the configuration and the new application. Because the criteria for identifier A is not met (2.2>2.0) the flashloader does not perform any actions. The result is the application version 2.2 remains in the module and the configuration remains unchanged.

It is to be understood that the method for assuring flash programming integrity which has been described, is merely illustrative of one application of the principles of the invention. Numerous modifications may be made to the device of the method as described without departing from the true spirit and scope of the invention.

What is claimed is:

1. A method for updating software applications in computerized controllers, comprising the steps of:
(A) embedding an identifier in each of the software applications that uniquely identifies the application;
(B) embedding in a software update a list of identifiers for the software applications that the update is authorized to update;
(C) determining whether the identifier of a software application present in a controller is present in the list embedded in a proposed software update; and,
(D) installing the proposed software update in the controller only if the identifier of the software application to be updated is determined in step (C) to be present in the list embedded in the proposed software update.

2. The method of claim 1, wherein step (C) is performed using a flashloader to compare the identifier of the software application present in a controller with the list embedded in the proposed software update.

3. The method of claim 1, wherein:
the software application to be updated is stored in a flash memory in the controller, and
step (D) is performed using a flashloader.

4. The method of claim 1, further comprising the steps of:
(E) maintaining a count of the number of times step (C) is performed for a proposed software update, and
(F) terminating attempts to install the software update if the count exceeds a preselected value.

5. The method of claim 1, wherein step (C) includes performing a checksum to verify the integrity of the software application present in a controller.

6. The method of claim 1, further comprising the step of encrypting each of the identifiers embedded in the software applications and the identifiers in the list.

7. The method of claim 1, wherein the update installed in step (D) forms only a portion of the software application present in a controller.

8. A method for updating software in a controller, comprising the steps of:
(A) storing a unique identifier in the controller that uniquely identifies the software present in the controller;
(B) storing with update software a list of the unique identifiers for software that the update software is authorized to update;
(C) determining whether the identifier stored in step (A) is present in the list of identifiers stored in step (B); and,
(D) updating the software in the controller with the update software only if the identifier is determined in step (C) to be present in the list.

9. The method of claim 8, further comprising the step of embedding the identifier in the software, and step (A) includes storing the software containing the embedded identifier in a memory in the controller.

10. The method of claim 9, further comprising the step of encrypting the location of the identifier within the memory.

11. The method of claim 8, wherein steps (C) and (D) are performed using a flashloader.

12. The method of claim 8, further comprising the steps of:
(E) storing a second copy of the unique identifier in the controller;
(F) determining whether the identifier used in the determination made in step (C) identically matches the second copy of the identifier stored in step (E); and
(G) terminating the update if the step (F) does not result in an identical match.

13. The method of claim 8, further comprising the steps of:
(E) maintaining a count of the number of times step (C) is performed for a proposed software update, and
(F) terminating attempts to update the software if the count exceeds a preselected value.

14. The method of claim 8, wherein step (C) includes performing a checksum to verify the integrity of the software in the controller.

15. The method of claim 8, further comprising the step of encrypting the stored identifier and Each of the identifiers in the list.

16. A method of updating a software application in a computerized controller, comprising the steps of:
(A) determining values for identifiers in a configuration stored in the controller;
(B) determining criteria that the identifier values in the configuration must satisfy in order for a software update to be authorized;
(C) determining whether the criteria are satisfied;
(D) if criteria are satisfied, performing a software update; and,
(E) if criteria are not satisfied, inhibiting the software update.

17. The method of claim 16, wherein the criteria are stored in the computerized controller.

18. The method of claim 16, wherein the criteria are stored in a new software application.

19. The method of claim 16, wherein step (C) is performed by using a flashloader that updates the software application.

20. The method of claim 16, wherein the values for identifiers in the configuration are embedded in the software application, and are embedded in a new software application using a flashloader.
